(19) United States
(12) Patent Application Publication
(10) Pub. No.: US 2007/0159935 A1
(43) Pub. Date: Jul. 12, 2007

(54) Height-determining method of an elevating device for a disc changer

(75) Inventor: Sheng-Hsu Chuang, Hsinchu City (TW)

Correspondence Address: BIRCH STEWART KOLASCH & BIRCH, PO BOX 747, FALLS CHURCH, VA, 22040-0747, US

(73) Assignee: LITE-ON IT CORP.

(21) Appl. No.: 11/649,234

(22) Filed: Jan. 4, 2007

(30) Foreign Application Priority Data
Jan. 6, 2006 (TW) 95100626

(51) Int. Cl. G11B 21/08; G11B 7/085

(52) U.S. Cl. 369/30.85

(57) ABSTRACT

A height-determining method of an elevating device comprises following steps. Firstly, the disc changer determines whether a disc storage cartridge is inserted into the disc changer or not. Secondly, the CPU resets the elevating device in the case that the disc storage cartridge is inserted into the disc changer. Then, the CPU calculates each level height of the disc storage cartridge, and so the elevating device can move according to the calculated level heights.

### FIELD OF THE INVENTION

The present invention relates to a method of determining a height of a elevating device, and more specifically to the method of that resets the look-up relationship between the height of the elevating device and the voltage of the variable resistor.

### BACKGROUND OF THE INVENTION

In the modern technology, most of data are transformed into a digital form in order to be stored in the computer. People can easily access data conveniently by various storing apparatuses. Among these storing apparatuses, disc and optical drive (disc player) have great influence on people's life. The disc for storing digital data has many characteristics such like low cost, small size, and big capacity.

The optical drive is not only applied to the computer but also to the motor stereo, home theater, and CD stereo, etc. In the art, a conventional disc changer has a disc storage cartridge for storing plural discs in a parallel and vertical way. In the disc changer, an elevating device usually moves up or down to draw a selected disc to play from the disc storage cartridge according to the command of the user.

Generally, the disc changer does not have a fix reference point for the elevating device to caliber its relative position or height with respect to each of the level plates of the disc storage cartridge for resting thereupon the discs. In the conventional disc changer, there is a built-in height table in the firmware to provide a designed height of each level of the disc storage cartridge and its related voltage. The elevating device can therefore consult the voltage of the variable resistor in the disc changer to move to a specific height of the selected level. The built-in height table is fixed and designed in advance, but the real height of each level is practically not the same as the height listed in designed built-in height table due to possible tolerances from the very first assembly process and the later-on operation. As a foreseen consequence of the ill height, the elevating device may fail to draw the selected disc. Even worse, the elevating device may crash and cause unexpected damage to the disc changer.

### SUMMARY OF THE INVENTION

The object of the present invention is to provide a height-determining method of an elevating device for a disc changer to reset the elevating device so as to get real height information of each level of a disc storage cartridge.

The object of the present invention is to provide a disc changer that can neglect the inherent tolerance from the mechanism set up process, and thus the maintenance period in calibrating the height of the elevating device can be substantially extended.

The height-determining method of the elevating device is applied to a disc changer, and the elevating device is moved around a disc storage cartridge of the disc changer. The height-determining method includes determining whether the disc storage cartridge inserted into the disc changer or not. When the disc storage cartridge is inserted into the disc changer, a CPU can reset the elevating device and calculate each level height of the disc storage cartridge. Then, by providing the correct level height table, the disc changer can. proceed a normal working mode.

In an embodiment of the present invention, the reset step of the present method comprises the following steps. Firstly, the elevating device is raised to the top level of the disc storage cartridge. Secondly, the disc changer is detected to obtain an analog voltage. Then, the analog voltage is transformed into a digital voltage. Finally, a new height table is provided to the disc changer by comparing the digital voltage with an anticipation height table established in the disc changer.

In one embodiment of the present invention, the new height table is obtained through an arithmetic progress by comparing with the digital voltage and the anticipation height table.

In one embodiment of the present invention, the analog voltage is measured at an output of a linear variable resistor of the disc changer.

In the present invention, the elevating device is moved according to the level height computed from the new height table at the normal working mode.

The disc changer, in the present invention, comprises a elevating device and a central processing unit (CPU). The elevating device is moved around plural levels of a disc storage cartridge. The CPU, coupled to the elevating device, is to calculate each level height so as to reset the elevating device when the disc storage cartridge is inserted into the changer.

In one embodiment of the present invention, the changer further comprises a linear variable resistor coupled to the elevating device and the CPU. The output voltage of the linear variable resistor is an analog voltage varied with the height of the elevating device.

### BRIEF DESCRIPTION OF THE DRAWINGS

The features, objects, and advantages of the present invention will become more apparent from the following detailed description of the preferred embodiment of this invention, with reference to the accompanying drawings, in which:

FIG. 1 is a top view of a preferred elevating device in accordance with the present invention;

FIG. 2 is a front view of a preferred disc changer in accordance with the present invention;

FIG. 3 is a back view of the changer of FIG. 2; and

FIG. 4 is a flow chart illustrating the height-determining method of the elevating device in accordance with the present invention.

### DETAILED DESCRIPTION OF THE EMBODIMENT

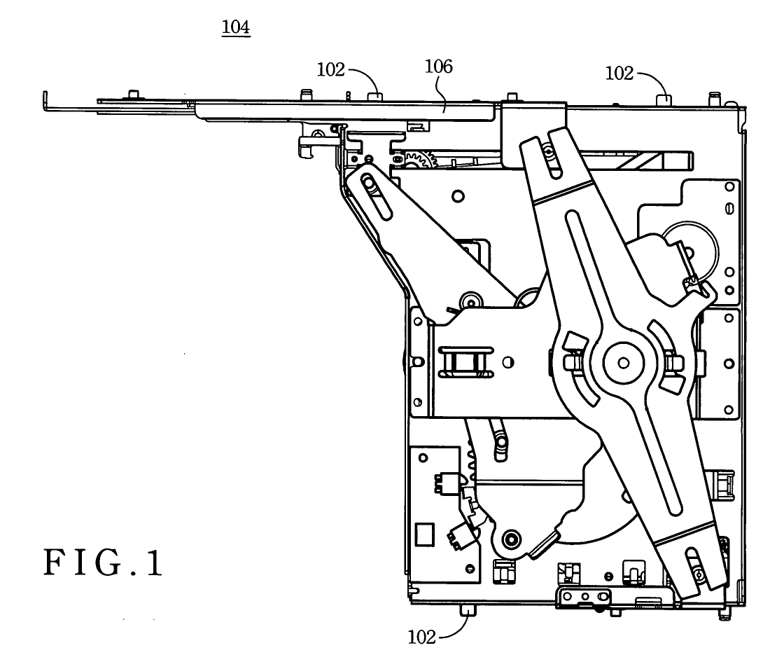

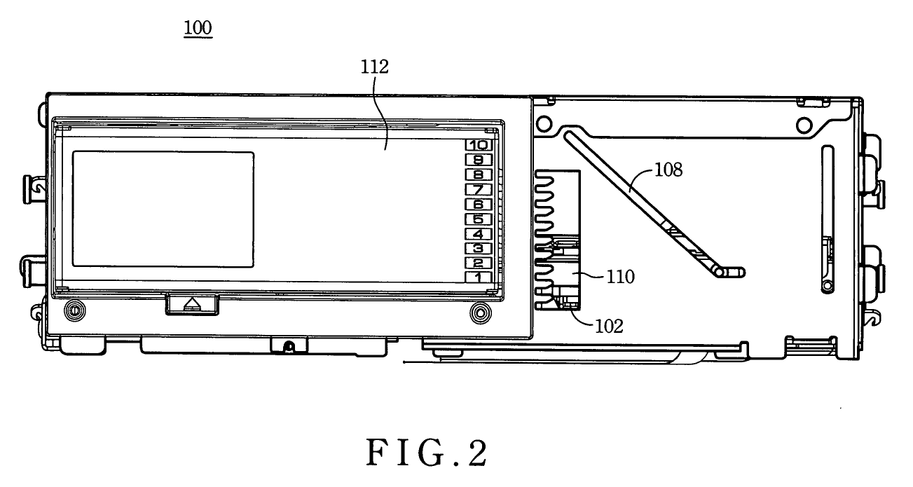

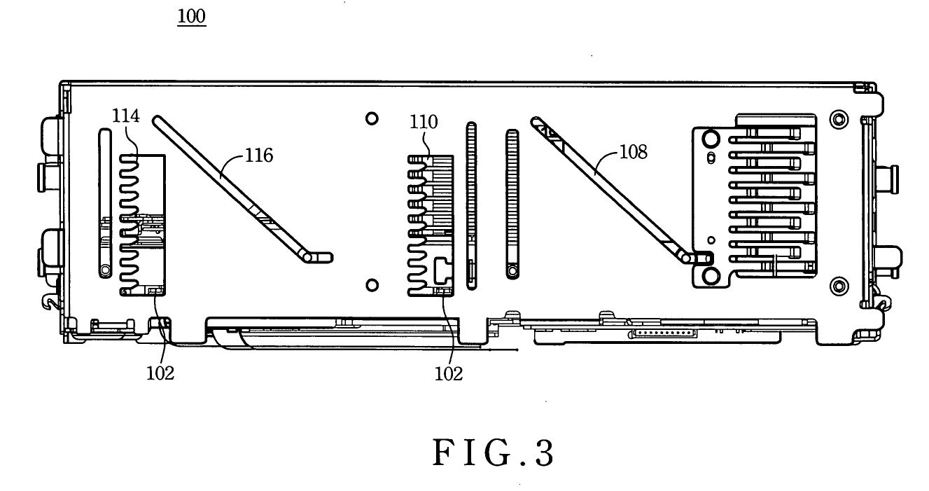

Please refer to FIG. 1, FIG. 2 and FIG. 3, which show a top view of a elevating device, a front view of a disc changer and a back view of the disc changer according to a preferred embodiment of the present invention, respectively.

A disc changer 100 comprises an elevating device, a central processing unit (CPU), and a disc storage cartridge. As shown in FIG. 1, the elevating device 104 movably set in the disc changer 100 comprises position points 102 and a linear variable resistor 106. The CPU (not shown in the figures), coupled electrically to the robot device 104 and the linear variable resistor 106, is located on the elevating device 104. The disc storage cartridge 112 can be inserted into the disc changer 100 and have plural levels (a capacity) to accommodate discs. For example, the disc storage cartridge 112 has ten levels to accommodate ten discs respectively as shown in FIG. 2.

The disc changer 100 has two slide-grooves 108,116 set at two side of the disc changer 100, respectively. The elevating device 104, guided by the slide-grooves 108, 116, is moved around sides of the multi-levels disc storage cartridge 112 according to the command of the user. The position points 102 are moved up and down along comb-like notches 110,114. When the elevating device 104 arrives at an anticipation level of the cartridge 112, the position points 102 would be located right at a specific finger slot of the notches 110,114 so as ready to draw the disc to play.

The linear variable resistor 106 is coupled electrically to the elevating device 104. The resistance of the linear variable resistor 106 is varied with the elevating device 104 moving up and down, and the voltage of the linear variable resistor 106 is also changes with the variation of the resistance under a constant current. In the present invention, an anticipation height table is provided in advance to elucidate the relation between the each level height (pitch or that is embodied by the finger slots of the notch) and the output voltage of the variable resistor 106. Therefore, the CPU can determine whether the elevating device 104 reaches the target level or not by judging the output voltage of the variable resistor 106 in the embodiment of the present invention.

The CPU, coupled electrically to the elevating device 104 and the linear variable resistor 106, is located on the elevating device 104. Every time when the disc storage cartridge 112 is inserted into the disc changer 100, the CPU can reset the elevating device 104 so as to calculate the new height of the each level.

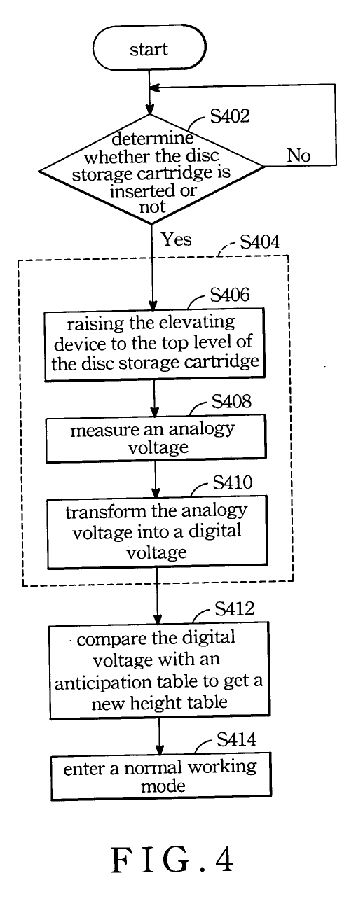

Please refer to the FIG. 4, which shows a flow chart of the height-determining method of the elevating device according to an embodiment of the present invention. When the disc changer is turned on, the CPU determines whether the disc storage cartridge is inserted into the disc changer or not (S402).

When the disc storage cartridge is inserted into the disc changer, the CPU outputs a command to the elevating device so as to initiate a reset operation (S404). On the contrary, when the disc storage cartridge is not inserted into the disc changer, the CPU keeps a standby state and returns to the step S402.

The steps of the reset operation of the elevating device include, first, raising the elevating device to the top level of the disc storage cartridge along the notches (S406). That is, the position points are raised to the top position of the notches. Second, the CPU measures an analog output voltage of the linear variable resistor (S408).

Third, the analog output voltage is converted into a digital voltage by the CPU of the disc changer or an analog-to-digital converter of the disc changer (S410). In the present invention, the disc changer can also apply other methods in the art to transform the voltage.

The CPU gets the digital voltage to denote that the elevating device is at the top level, and then the CPU compares with said anticipation table established in advance in the disc changer so as to figure out a new top level height of the disc storage cartridge. Then, a new height table can be obtained from the existed anticipation table and the output voltage of the linear variable resistor as the elevating device at the top height of the disc storage cartridge by applying interpolation, curve-fitting or other arithmetic methods. These arithmetic methods are well known in the art, and so details would be omitted herein.

For example, the top level is assumed to be the N-th level, and the new top level height is defined to be H. The difference height in adjacent levels (pitch) is a fixed value defined by a number D.

After reaching the top level height H, the height of each level is calculated by an arithmetic progression. For example, the height of the (N-1)th level is (H-D), the height of the (N-2)th level is (H-2D), and the height of the first level is (H-ND). The CPU can then establish the new height table according to the new level heights (S412).

Finally, the changer enters a normal working mode to wait for a user command (S414).

The CPU can reset the relation between the height of each level and the voltage of the linear variable resistor every time when the disc changer is turned on or the disc storage cartridge is inserted into the disc changer.

Therefore, by providing the height-determining method to the disc changer, the inherent tolerance of the disc changer can then be neglected without sacrificing the operation accuracy of disc changing in the disc changer.

Although the present invention and its advantages have been described in detail, as well as some variations over the disclosed embodiments, it should be understood that various other changes, substitutions and alterations can be made herein without departing from the spirit and scope of the invention as defined by the appended claims.

What is claimed is:

1. A height-determining method of an elevating device applied to a disc changer, said disc changer including a disc storage cartridge having plural levels, comprising:
(a) determining whether said disc storage cartridge is inserted into said disc changer;
(b) resetting the elevating device in the case that said disc storage cartridge is inserted into the changer;
(c) calculating each level height of said levels of said disc storage cartridge; and
(d) entering a normal working mode.

2. The height-determining method according to claim 1, wherein said step (b) further comprises:
(b1) raising said elevating device to a top level of said disc storage cartridge;
(b2) measuring an analog voltage;
(b3) transforming the analog voltage into a digital voltage; and
(b4) comparing the digital voltage with an anticipation height table provided in advance in said disc changer to get a new height table.

3. The height-determining method according to claim 2, wherein said new height table is performed by an arithmetic progression.

4. The height-determining method according to claim 2, wherein said step (b2) is performed by measuring an output value of a linear variable resistor in said disc changer.

5. The height-determining method according to claim 1, wherein said step (d) is to have said elevating device moved according to said level height.

6. A disc changer, used to insert a disc storage cartridge, comprising:
an elevating device moved around plural levels of said disc storage cartridge; and
a central processing unit (CPU), coupled to said robot device, wherein, when said disc storage cartridge is inserted into said disc changer, said CPU resets said elevating device to producing each correct level height of said levels of said disc storage cartridge.

7. The disc changer according to claim 6; further comprising a variable resistor, coupled to said elevating device and said CPU, an analog voltage of said variable resister being obtained according to a location of said elevating device.
